(19) United States
(12) Patent Application Publication
(10) Pub. No.: US 2005/0206741 A1
(43) Pub. Date: Sep. 22, 2005

(54) Law enforcement vehicle surveillance system

(76) Inventor: Gregory W. Raber, Naperville, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 11/082,314

(22) Filed: Mar. 17, 2005

Related U.S. Application Data
(60) Provisional application No. 60/554,499, filed on Mar. 19, 2004.
(60) Provisional application No. 60/602,190, filed on Aug. 17, 2004.

(51) Int. Cl. H04N 5/232

(52) U.S. Cl. 348/211.2

(57) ABSTRACT

The invention provides a law enforcement vehicle camera surveillance system including a nonvolatile memory in signal-communication with the camera to store the images as data files, and a transmitter to transmit the data files. The invention includes a wireless signal from the transmitter automatically when the vehicle subsystem is within a pre-selected distance from a base station subsystem and to transfer the data files into storage media at the base station. The invention can also comprise a microphone in signal-communication with the nonvolatile memory wherein audio data files correspond to the images is stored in the nonvolatile memory.

This application claims the benefit of U.S. Provision Application Ser. No. 60/554,499 filed Mar. 19, 2004 and U.S. Provision Application Ser. No. 60/602,190 filed Aug. 17, 2004.

### FIELD OF THE INVENTION

The present invention is directed to a law-enforcement vehicle surveillance system. More particularly, the present invention is directed to a law-enforcement vehicle surveillance system having improved automation capabilities.

### BACKGROUND OF THE INVENTION

Police cars and other emergency vehicles such as ambulances and fire trucks, carry a number of necessary peripheral subsystems that must be activated and controlled by the vehicle operator. One such peripheral is the video recording system used in law-enforcement vehicles to maintain a record of the events that take place during a particular law enforcement action, such as a typical traffic stop. In law-enforcement, such a routine traffic stop can be deceptively safe or one of the most dangerous situations that they encounter. Accordingly, for the protection of the officer, as well as for the protection of the public, having a record of such an incident has become increasingly important.

One example of a typical video recording system used in law-enforcement vehicles is shown in U.S. Pat. No. 4,789,904, issued Dec. 6, 1988, to Peterson. The system shown in the '904 patent includes a camera and control head that are mounted within the vehicle cabin, and a video recorder housed in a vault disposed in the trunk of the vehicle. The system also includes a wireless microphone that is carried by the police officer. The video recorder stores the video and audio to a tape, such as a standard 8 mm videotape. The system is manually activated by the police officer upon stopping a motorist or when the officer wishes to videotape driving behavior of a motorist. Although the '904 patent references automatic activation of the surveillance system, neither the conditions for such activation nor the structure for any such activation are shown or described.

As the needs of law-enforcement escalate without a corresponding increase in budgets, the requirement for optimized law-enforcement tools that are more reliable and streamlined than existing tools is apparent. The present inventor has recognized this need and has developed an improved and automated law-enforcement vehicle surveillance system.

### SUMMARY OF THE INVENTION

The preferred embodiment of the invention provides a law enforcement vehicle surveillance system that includes a vehicle subsystem including a camera for capturing images of an area adjacent to the vehicle and a nonvolatile memory in signal-communication with the camera to store the images as data files, and a transmitter to transmit the data files. The preferred embodiment of the invention includes a base station subsystem comprising a receiver and a base storage media, the receiver configured to receive the data files as a wireless signal from the transmitter automatically when the vehicle subsystem is within a pre-selected distance from the base station subsystem and to transfer the data files into the base storage media.

The preferred embodiment of the invention also provides for the wireless signal to be encrypted.

The preferred embodiment of the invention provides that the nonvolatile memory is a random access memory.

The preferred embodiment of the invention can also comprise a microphone in signal-communication with the nonvolatile memory wherein audio data files correspond to the images is stored in the nonvolatile memory.

The preferred embodiment of the invention can also comprise a MARS light switch signal converted to the vehicle subsystem such that actuation of the MARS by the MARS light switch also activates the vehicle subsystem to start storing images.

The preferred embodiment of the invention can also provide that the nonvolatile memory is stored in a box located in the vehicle glove box.

The preferred embodiment of the invention provides a law enforcement vehicle surveillance system, that includes a vehicle subsystem including a camera for capturing images of an area adjacent to the vehicle and a memory in signal-communication with the camera to store the images as data files, and a transmitter to transmit the data files. A base station subsystem comprises a receiver and a base storage media, the receiver configured to receive the data files as a wireless signal from the transmitter automatically when the vehicle subsystem is within a pre-selected distance from the base station subsystem and to transfer the data files into the base storage media.

The preferred method of the invention provides a method of operating a law enforcement surveillance system comprising the steps of:

starting up the system;

recovering partial image files;

initializing pre-recording of image files;

beginning to pre-record for a preset time period in a continuous loop of preset duration;

upon actuation of a selectable start signal, exiting the continuous loop and storing pre-recorded image data and continuing to record image data;

after actuation of a selectable stop signal, storing the image data; and

transferring the image data to a base system.

The preferred method can comprise the further step of after actuation of the selectable stop signal, recording image data for a preset time period before transferring the image data.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a block diagram of one embodiment of an overall law-enforcement vehicle surveillance system.

FIG. 2 is a flow chart illustrating one manner of operating the vehicle subsystem of FIG. 1 for recording purposes.

FIG. 3 is a flow chart illustrating one manner in which the vehicle subsystem and the base station subsystem of FIG. 1 may be operated to transfer and store media files recorded by the vehicle subsystem.

FIG. 4 is a diagrammatic view of electronics of the vehicle subsystem arranged to be mounted in the vehicle.

FIG. 5 is a diagrammatic sectional view taken generally along line 5-5 of FIG. 4.

FIG. 6 is a table corresponding to the pins shown in FIG. 5.

FIG. 7 is a wiring diagram corresponding to the connector shown in FIGS. 5 and 6.

FIG. 8 is a schematic diagram of one aspect of the system of the invention.

### DESCRIPTION OF THE PREFERRED EMBODIMENT

This application incorporates U.S. Ser. No. 60/554,499 filed Mar. 19, 2004 and U.S. Ser. No. 60/602,190 filed Aug. 17, 2004, by reference.

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

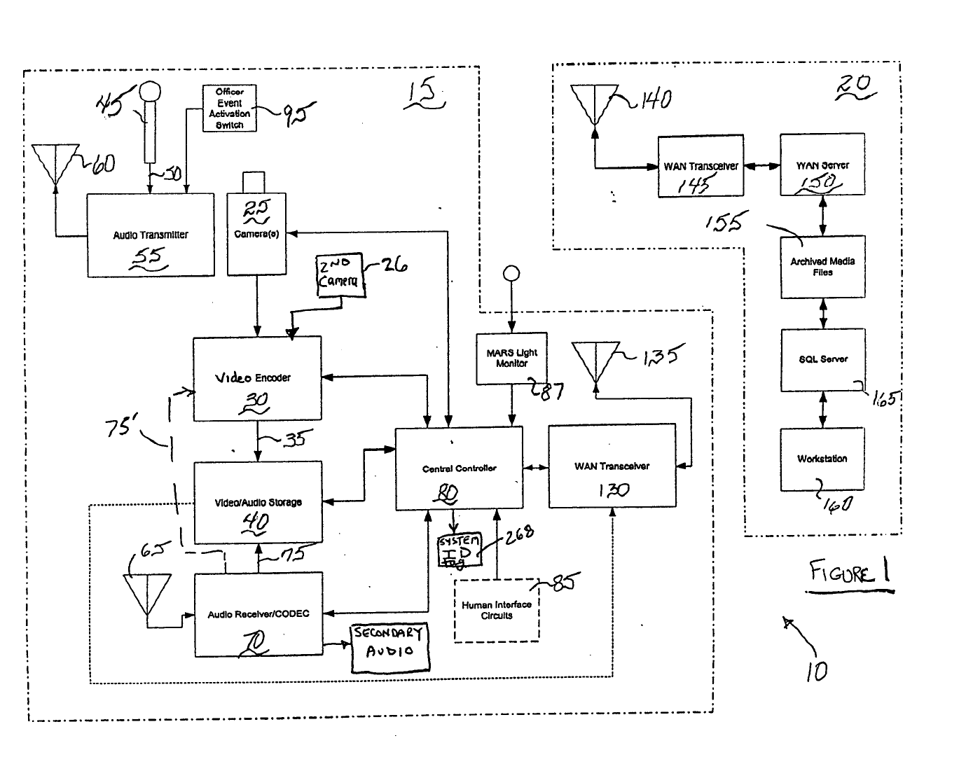

FIG. 1 is a schematic block diagram of one embodiment of an overall law-enforcement vehicle surveillance system, shown generally at 10. System 10 is generally divided into a vehicle subsystem 15 and a base station subsystem 20. Vehicle subsystem 15 operates to record the video and audio associated with a law-enforcement event, such as a routine traffic stop. The recording is stored as a media file within vehicle subsystem 15. The stored media file is later retrieved by the base station subsystem 20 over, for example, a wireless network. The base station subsystem 20 archives the media file and catalogs it to make it available for fast retrieval using, for example, a database system.

As illustrated, the vehicle subsystem 15 includes a camera 25 that provides a video output signal to an MPEG encoder 30. Preferably, camera 25 is mounted within the law-enforcement vehicle at a position to observe all of the transactions that may take place during a given law-enforcement event. Preferably, the camera 25 is mounted on the windshield. A second camera(s) 26 can be mounted to view other areas or to view into the vehicle, such as into the backseat area of the vehicle. MPEG encoder 30 is provided to accept the video signal or video data signal output of camera 25 and provide a corresponding compressed digital video signal at output 35. The compressed digital video signal is available for storage on storage media present in a video/audio storage device 40. The storage media used in device 40 may be comprised of one or more media types, such as RAM, hard disc drives, videotape, etc. Preferably, however, the storage media is in the form of one or more nonvolatile, RAM memories such as FLASHDISK or COMPACT FLASH storage devices.

Audio relating to the law-enforcement event is provided through a wireless microphone system carried by the law-enforcement officer. In the illustrated embodiment, the wireless microphone system includes a microphone 45 that provides an audio output signal at line 50 to the input of audio transmitter 55. Audio transmitter 55, in turn, modulates the audio signal to generate a radio frequency transmission that is provided to antenna 60.

The transmission radiated by antenna 60 is received by antenna 65 where it is demodulated by an audio receiver 70. Preferably the audio receiver is mounted in the vehicle under the front seat. Preferably, audio receiver 70 also includes an analog-to-digital converter and audio codec to generate digital audio at output 75 that is in synchronization with the digital video at output 35. As shown, the digital audio at output 75 is available for storage in the storage medium of the video/audio storage device 40. Alternately, the output 75′ can be sent to the MPEG Encoder.

In the illustrated embodiment, the various system components are placed under the control of a central controller 80. Central controller 80 may be comprised of a central processing unit executing a standard operating system as well as customized user software. To this end, central controller 80 may be connected to an interface unit 85 that allows a user to program and maintain the vehicle subsystem 15 via traditional human interface devices such as a keyboard, mouse, display, etc. Alternatively, as will be set forth below, such programming and maintenance may take place over a wireless interface.

A video monitor can be built into a sun visor, and corresponding viewing controls (not illustrated) may also be employed as part of the vehicle subsystem 15 to allow an officer to review one or more of the recorded law-enforcement events. However, the viewing controls should not allow an officer the opportunity to delete or otherwise tamper with a recorded media file.

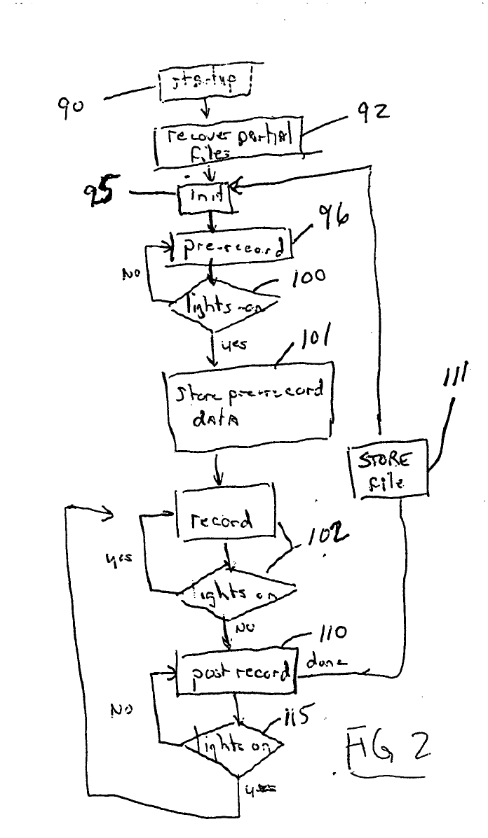

Among its many responsibilities, central controller 80 may be programmed to execute a recording sequence such as the one shown in FIG. 2. In the specific embodiment of the recording process illustrated here, a continuous record of video and audio would likely prove to be too storage intensive. Accordingly, audio and video are only recorded for a short period of time prior to an event (pre-recording duration), during the entire time that the event is taking place (event duration), and for a short period of time after the event is completed (post-recording duration).

In the illustrated embodiment, the state of the MARS (manually activated roof mounted lights/siren) lights switch 87 is monitored by the central controller 80 to determine whether a law-enforcement event is in progress. If the switch 87 has been activated to turn on the MARS lights, central controller 80 assumes that a law-enforcement event is in progress. Completion of the event is assumed once the MARS light switch 87 has been deactivated after a prior activation cycle. In addition, or in the alternative, a remote event activation switch 95 may be provided as part of the wireless microphone system worn by the law-enforcement officer. For example, switch 95 may be activated to generate a tone of a predetermined frequency and duration that is ultimately detected by the central controller 80 and used to trigger the initialization (or termination) of a law-enforcement event.

FIG. 2 illustrates one manner in which the vehicle subsystem 15 may respond in both an ordinary response mode and an event response mode. As shown, pre-recording is initialized at step 90 and the pre-recording timer is initialized at step 95, and pre-recording starts at step 96. The value of the pre-recording timer is used to determine the pre-recording duration for the media files that are to be stored by the vehicle subsystem 15. For example, the recording timer may be set to a value of 30 seconds, in which case 30 seconds of video and audio will be recorded and pre-pended to an event or, alternatively, overwritten if no law-enforcement event is initiated within that 30 second duration of timer.

At step 100, controller 80 checks the input from the MARS light monitor circuit 87 to determine whether the MARS lights of the law-enforcement vehicle have been switched on. If the lights have been switched on, the vehicle subsystem 15 starts to store pre-recorded data at step 101 and at step 102 enters a continuous recording mode in which it is assumed that a law-enforcement event is in progress. Both video and audio are continuously recorded throughout the duration of the law-enforcement event.

Optionally, upon initial detection that an event is in progress, central controller 80 may direct camera 25 to zoom in to a predetermined focal length for a predetermined period of time to gather close-up information regarding the event. As an example, the camera can zoom in from a set focal length to 21×, hold for 5 seconds and then return to the set focal length. Such an automatic zoom control may provide a close-up of the individual driving a car that has been stopped by the officer and/or provide a view of the license plates of that car. In addition to this zoom function, central controller 80 may be programmed to direct camera 25 to make an initial vertical and/or horizontal pan of the event scene to provide even further details that relate to the event. Once this initial zoom and/or scan has been completed, the focal length and pan of the camera 25 are returned to place the camera in its original state.

When the MARS lights have just been shut off, the vehicle subsystem 15 continues to record audio and video for a predetermined post-recording duration at step 110. Once the post-recording duration has elapsed, the entire media file for the law-enforcement event (pre-recording duration, the event duration, and post-recording duration) is stored in the video/audio storage device 40 in an archive or other storage area at step 111 that is configured to transmit its contents at the appropriate time to the base station subsystem. The central controller 80 preferably identifies the stored media file with at least one or more of the following pieces of information: 1) start time of the law-enforcement event, 2) end time of the law-enforcement event, 3) law-enforcement vehicle unit number, and 4) the name of the police department or division.

The system then reverts to step 95 and the process begins again from that step. If at step 115 during the post-recording, the MARS lights are turned on the system goes to step 102 to resume event recording.

As described above, the vehicle subsystem 15 may respond to an officer initiated law-enforcement event when the officer activates switch 95 of the wireless microphone system. Although switch 95 is shown as part of the wireless microphone system, it can also be provided as a separate wired or wireless unit. In either instance, the process of FIG. 2 can be readily modified to accommodate the additional activation mode.

The vehicle subsystem 15 can include a power-down function to ensure the integrity of the recorded information and the components. If the subsystem 15 is powered up and the vehicle engine is not running, the subsequent actuation of the ignition will tend to disrupt the supply voltage to the system. To protect the system and the recorded data, upon actuation of the ignition, the vehicle subsystem 15 immediately powers down or turns off for a pre-determined interval (e.g., 10 seconds) and is then automatically turned on and reboots. If the subsystem 15 is off when the ignition is actuated, it will be inoperative to be turned on for the predetermined interval.

With reference again to FIG. 1, the vehicle subsystem 15 also includes several components for communicating with the base station subsystem 20. To this end, vehicle subsystem 15 is provided with a wireless transceiver 130 that is connected to send and receive radio frequency data transmissions via antenna 135. Communications between the vehicle subsystem 15 and the base station subsystem 20 may proceed using either a proprietary communication format or a common data transmission format, such as TCP/IP.

In addition to the transfer of video and audio media corresponding to a law-enforcement event, the communications may also be used in the routine maintenance of the vehicle subsystem 15. For example, the software executed by subsystem 15 may be updated through transmissions of program updates from the base station subsystem 20. Further, vehicle subsystem 15 may be programmed to execute a self-check and to notify the base station subsystem 20 of any malfunctions.

The base station subsystem 20 likewise includes its own antenna 140 and wireless transceiver 145 for use in communicating with the vehicle substation 15. The data communications between the vehicle subsystem 15 and base station subsystem 20 are preferably coordinated by the central controller 80 in subsystem 15 and a wide area network server 150 in subsystem 20. The base station subsystem 20 can access the vehicle subsystem 15 via alphanumeric coding (e.g. recorder 134847 went into unit #850) to overlay data remotely, to program time/date and unit number. Both the recording unit and wireless unit are given individual IP addresses for this process.

Video and audio data received by the base station subsystem 20 from the vehicle subsystem 15 is ultimately archived in a media storage system 155. The video and audio data can be initially transferred to a hard drive and when the hard drive is x% full then the system manager is notified. The notifications are made at increasing intervals until capacity is reached. A backup can be used at capacity. Preferably before capacity is reached, the video and audio data is transferred to a CD, DVD or tape for archiving. After transfer, a summary of the beginning time/date and end time/date is displayed for labeling and logging. Media storage system 155 may include, for example, one or more jukebox style DVD storage and retrieval units. The media storage system 155 may alternatively (or in addition) be comprised of multiple high-density hard drive systems. Other forms for the media storage system may also be utilized depending on system design requirements.

The media files stored in system 155 are preferably accessible by, for example, a computer workstation 160 via a database server 165, such as an SQL server, for selective viewing. The media files are retrievable using at least one search queue criterion such as the vehicle unit number, the date and time of the recorded event, the police report number (for correlating the media file with a corresponding police report prepared by the officer), etc.

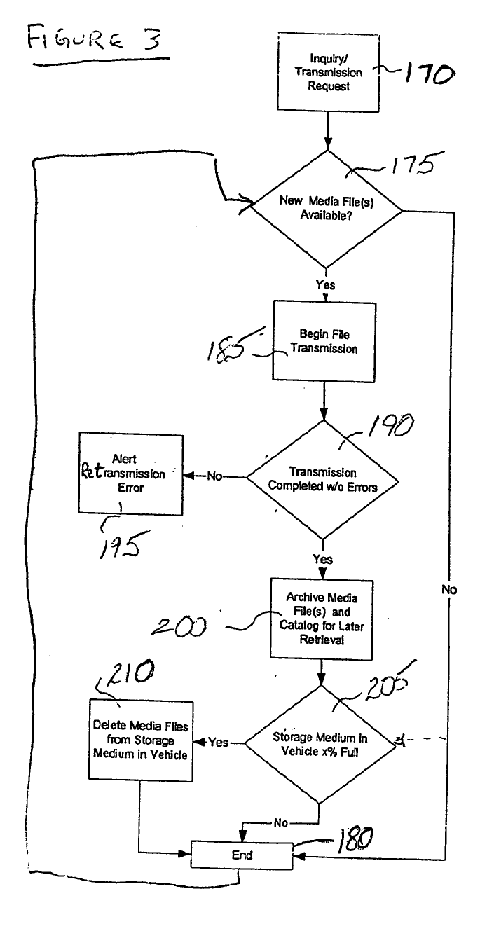

FIG. 3 illustrates one manner in which the transfer, archiving and maintenance of media files in the overall system 10 may be coordinated. When the law-enforcement vehicle returns to within a certain distance to, or at, the police station, either a wireless transmission inquiry is made by base station subsystem 20 or a wireless transmission request is made by vehicle subsystem 15 at step 170. Any such inquiry or request can be initiated automatically or manually and is executed to open and establish a communication link between the subsystems. Once this link is stabilized, a determination is made at step 175 as to whether there are any new media files in the vehicle subsystem 15 that need to be downloaded to the base station subsystem 20. If there are no new files, the process may be ended at step 180.

If new media files are available for download, the transmission of the media files between the vehicle subsystem 15 and the base station system 20 may begin at step 185. A check is then made at step 190 to determine whether the transmission of all media files has been completed without any transmission errors. If errors have occurred, then attempts may be made at retransmitting the files. If the errors continue, one or both of the subsystems 15 and 20 provide a user alert indication of the error at step 195 thereby notifying a user that service of one or both subsystems may be necessary or that an alternative means of downloading the media files may be required. If no errors occur and the media files have been successfully downloaded from the vehicle subsystem 15, the media files are stored in the archived media file system 155 at step 200. If no data is transmitted, the subsystem 20 will send an alarm message to the server, which alarms the system manager. In prior art systems using tape or hard drives that can hold many shifts in memory, malfunctions that occur in recording may not be discovered until the tape or hard drive is removed for uploading, wherein it is possible that more than one shift has transpired since the malfunction occurred. Thus, valuable data can be missed.

The subsystem 15 can include a further power-down function wherein the subsystem 15 will power down or shut off after a pre-selected interval (e.g., 1½ hours) after the vehicle ignition is turned off. Thus, after the vehicle returns to the station, and the vehicle ignition is turned off, and the subsystem 15 begins uploading data to the base station subsystem 20, the subsystem 15 will be powered down after the interval expires. Absent a malfunction in the subsystem 15 or the subsystem 20, the amount of data from the subsystem 15 can be transferred within the pre-selected interval. This feature prevents vehicle battery power drainage in the event of a subsystem 15 or subsystem 20 uploading malfunction. Additionally, the subsystem 15 can include a power-down function which is triggered when all data has been uploaded to the base station subsystem 20. The subsystem 15 senses the end of uploading and automatically powers down the subsystem 15.

As a practical matter, video/audio storage device 40 of the vehicle subsystem 15 has a limited storage capacity. Accordingly, some procedure for discarding old media files may be employed. To this end, an inquiry is made at step 205 to determine how much storage is available in device 40. If the available storage falls below a predetermined amount, the media files in the storage device 40 are overwritten/discarded at step 210. For example, if the total amount of data stored on storage system 40 exceeds x%, the old media files are overwritten/discarded. As such, the vehicle subsystem will typically have enough media storage to complete an entire duty shift.

The foregoing system can be physically organized in many different manners. For example, MPEG encoder 35, video/audio storage device 40, audio receiver/CODEC 70, central controller 80, MARS light monitor 87 and transceiver 130 may be constructed as a single unit that fits within the glove compartment of the vehicle. Transceiver 145 and server 150 may be networked into the system manager's desktop or may be constructed from a laptop computer having the appropriate software. The laptop computer can be brought proximate the law-enforcement vehicle when it arrives at the station to allow any new event media files to be downloaded. Once they are downloaded, the laptop may be moved to a different location to facilitate transfer of the media files to the archived media file storage system 155. Alternatively, the laptop computer may include a DVD burner to directly archive the media files.

The processes set forth in FIGS. 2 and 3 likewise can be allocated between the different structures of the system of FIG. 1. Thus, the processes set forth in FIG. 2 can be allocated between the central controller 80 and the other components of the vehicle subsystem 15. Similarly, some of the processes of FIG. 3 can be divided between the vehicle subsystem 15 and the base station subsystem 20 without effecting the overall operation of the system 10.

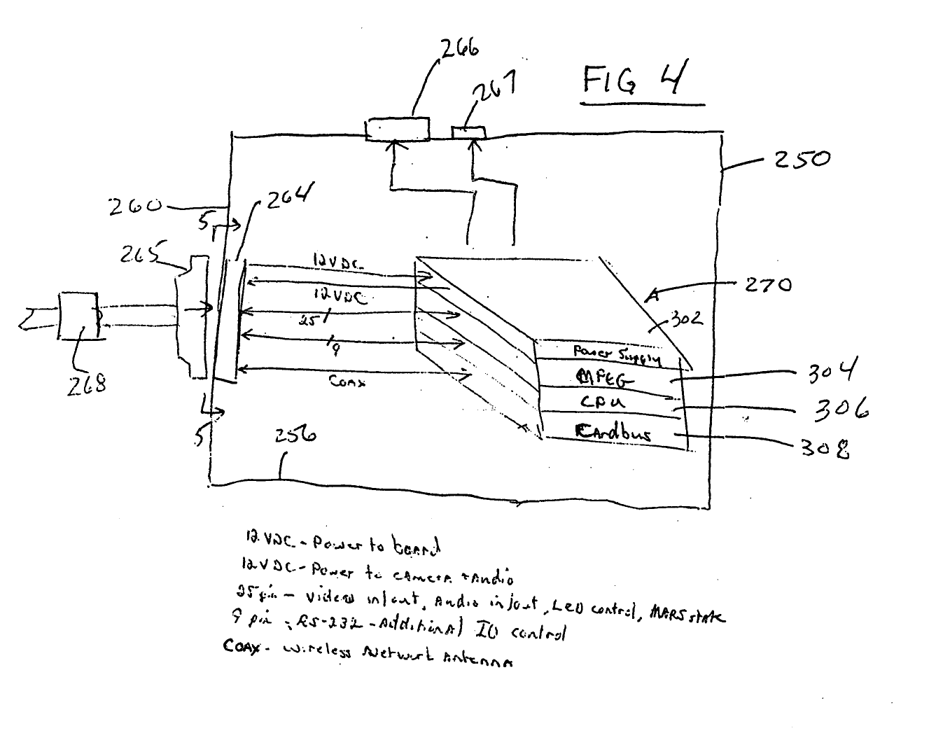

FIG. 4 illustrates in schematic fashion electronic components of the vehicle subsystem 15 mounted within a compact box-like housing 250 to be fixed into a glove compartment of the vehicle. Although the housing is shown much larger than the electronics, advantageously the housing would be sized only as large as necessary to contain the electronics. A layer of adhesive tape can be pre-mounted within the glove compartment and the housing 250 can be secured to the tape. Alternatively, the housing 250 can be mounted beneath one of the automobile seats or elsewhere in the vehicle.

A stack 270 of electronic boards and spacers/connectors is mounted onto a bottom wall 256. Another wall 260 of the housing 250 includes a connector 264 for connecting board wiring from the inside of the housing 250 to a connector 265 for vehicle wiring from outside of the housing 250. The housing 250 can include a cooling fan 266 and a status indicator LED on lamp 267.

The stack 270 can comprise a power supply board 302, an MPEG encoder board 304, a CPU board 306 and a PCMCIA adaptor board or card bus 308. FIG. 4 also shows cabling from the individual boards to the connector 264.

The cabling from top to bottom on FIG. 4 comprises:

12V DC power to board;

12V DC power to camera and audio;

25 pin video in/out audio in/out, LED control, MARS state;

9 pin, RS-232-additional IO control; and

Coax wireless network antenna.

As part of each installation, a unique ID tag can be included as part of the vehicle system harness, shown schematically at 268. This ID will be able to be accessed by the vehicle subsystem 15, particularly by the central controller 80. The ID in turn will be used when communicating with the server 150 in order to establish the unit name as well as other configuration information (IP address, etc.). This will allow for system upgrades and replacements without the need for manual configuration. In the event that the server 150 is not available to obtain the information, the unique ID from the tag 268 will be used in place of the unit name until the server can be contacted.

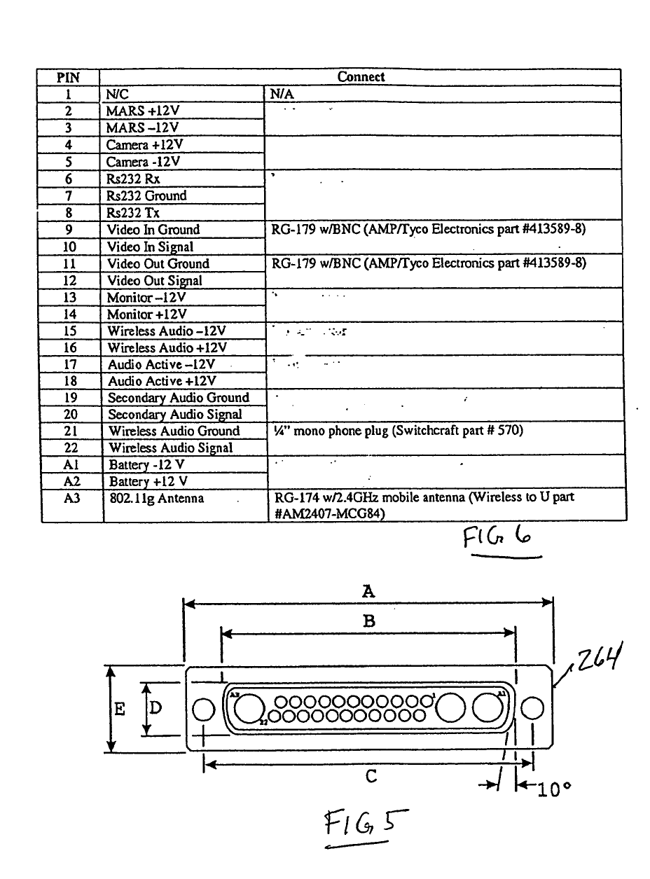

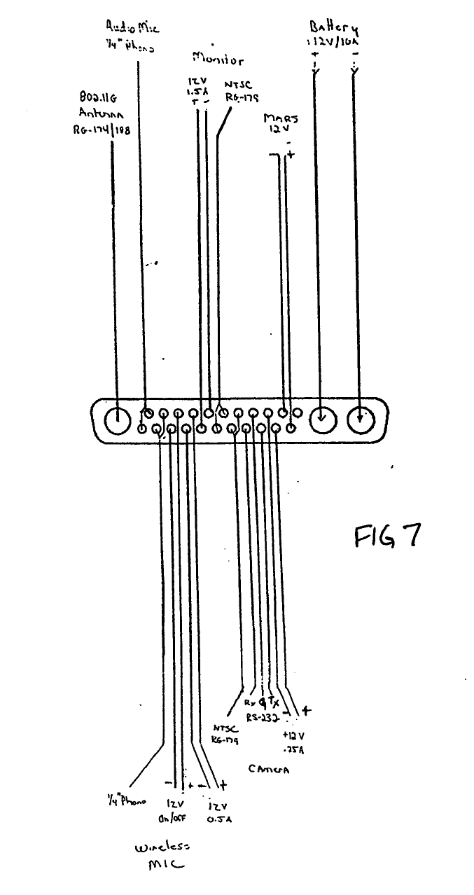

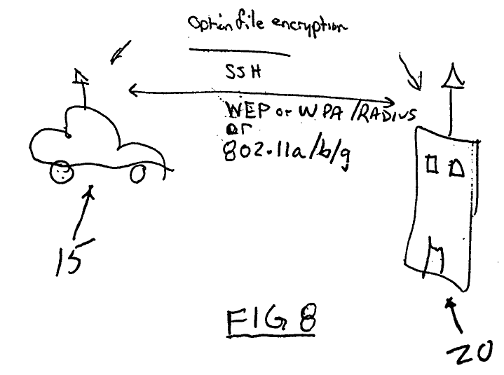

FIGS. 5-7 illustrate the connector 264 for the housing wherein multiple signal wire and signal cable connectors can be replaced with a single pin connector. The function chart of FIG. 6 shows how multiple functions can be allocated to the pins of the connector 264.

FIG. 8 illustrates schematically the communication between the emergency vehicle and the station using wireless encryption protocol (WEP), wireless protected access (WPA), for wireless network antenna, SSH or 802.1X. A WiFi network (802.11a/b/g) utilizing wireless access (WPA) with RADIUS server and optionally secured shell (SSH) can be used for additional security.

Numerous modifications may be made to the foregoing system without departing from the basic teachings thereof. Although the present invention has been described in substantial detail with reference to one or more specific embodiments, those of skill in the art will recognize that changes may be made thereto without departing from the scope and spirit of the invention.

There can be variations to the system of the invention. The system can have MARS “lights on” activation where the system will save all pre-recorded information and any subsequent video or audio—wherein audio is not pre-recorded. Turning the MARS “lights off” will turn off the system. The system can be activated by the audio transmitter. The system will save all pre-recorded information and any subsequent video or audio—audio is not pre-recorded. Turning the audio unit off will de-activate the video and audio recording.

A video screen can be provided on the visor. The visor video screen is activated with MARS “lights-on” system activation. Turning the MARS “lights-off” will turn the visor video screen off. Activation of the system using the audio transmitter does not turn on the visor video screen.

The camera can have optimal settings for in-car police video applications. Auto focus and auto iris have been enabled.

The officer can control auto-zoom and zoom functions. Pressing auto-zoom on the soft-touch key pad will move the zoom setting to 4×—where the system will hold on for 10 seconds before resuming normal zoom levels. The non-automated zoom functions are operated manually.

To quickly return to normal view from a zoom view, the auto-zoom can be pressed. The front-mounted camera is visible to the officer from in front of the car. The camera can have lights indicating that the video and audio are working. A green light indicates the unit is powered and a flashing red light indicates recording is in progress. Another light indicator such as a continuous red light indicates a malfunction.

A global positioning system (GPS) can be incorporated into the vehicle subsystem 15, wherein the exact location of the vehicle can be monitored and corresponding position information can be incorporated into the recorded data. The position information can be imprinted on, and displayed with the digital image during playback. A control button can be provided in the vehicle to record an instantaneous vehicle position upon manual actuation of the button, using the GPS. For example, during police pursuit of a suspect, it is not uncommon for the suspect to throw contraband out the window of the fleeing vehicle. If the officer in pursuit sees this, actuation of the button will mark the instantaneous location of the police vehicle which will assist in retrieving the contraband. This location information can also be imprinted on the stored data, to be visually observed during playback.

1. A law enforcement vehicle surveillance system, comprising:
a vehicle subsystem including a camera for capturing images of an area adjacent to the vehicle and a nonvolatile memory in signal-communication with said camera to store said images as data files, and a transmitter to transmit said data files;
a base station subsystem comprising a receiver and a base storage media, said receiver configured to receive said data files as a wireless signal from said transmitter automatically when said vehicle subsystem is within a preselected distance from said base station subsystem and to transfer said data files into said base storage media.

2. The system according to claim 1, wherein said wireless signal is encrypted.

3. The system according to claim 1, wherein said nonvolatile memory is a random access memory.

4. The system according to claim 1, comprising a microphone in signal-communication with said nonvolatile memory wherein audio data files correspond to said images is stored in said nonvolatile memory.

5. The system according to claim 1 further comprising a MARS light switch signal converted to said vehicle subsystem such that actuation of said MARS by said MARS light switch also activates said vehicle subsystem to start storing images.

6. The system according to claim 1, wherein said nonvolatile memory is stored in a box located in the vehicle glove box.

7. A law enforcement vehicle surveillance system, comprising:
a vehicle subsystem including a camera for capturing images of an area adjacent to the vehicle and a memory in signal-communication with said camera to store said images as data files, and a transmitter to transmit said data files;
a base station subsystem comprising a receiver and a base storage media, said receiver configured to receive said data files as a wireless signal from said transmitter automatically when said vehicle subsystem is within a preselected distance from said base station subsystem and to transfer said data files into said base storage media.

8. A method of operating a law enforcement surveillance system comprising the steps of:
starting up the system;
recovering partial image files;
initializing pre-recording of image files;
beginning to pre-record for a preset time period in a continuous loop of preset duration;
upon actuation of a selectable start signal, exiting said continuous loop and storing pre-recorded image data and continuing to record image data;
after actuation of a selectable stop signal, storing said image data; and
transferring said image data to a base system.

9. The method according to claim 8 comprising the further step of after actuation of the selectable stop signal, recording image data for a preset time period before transferring said image data.
